(19) United States
(12) Patent Application Publication
(10) Pub. No.: US 2024/0068782 A1
(43) Pub. Date: Feb. 29, 2024

(54) VIRTUAL FIREARMS TRAINING SYSTEM

(71) Applicant: Simulation Training Group Pty Ltd, Ashmore (AU)

(72) Inventor: Daryl Batchelor, Gold Coast (AU)

(21) Appl. No.: 17/924,793

(22) PCT Filed: May 14, 2021
(86) PCT No.: PCT/AU2021/050455

§ 371 Date: Nov. 11, 2022

(30) Foreign Application Priority Data
May 14, 2020 (AU) 2020901552

(51) Int. Cl. F41G 3/26

(52) U.S. Cl. CPC F41G 3/2611

(57) ABSTRACT

A firearms training system is provided that enables safe and efficient firearms training, e.g. in the home, using a real firearm. The system comprises: one or more sensors, configured to be mounted to the firearm and to track an orientation of the firearm; and a display, configured to be mounted to a firearm and to display a virtual environment in which the firearm may operate, the virtual environment updated according to an orientation of the firearm. The display is mounted to the firearm to in a manner to that simulates the firearm being used in the virtual environment.

### TECHNICAL FIELD

The present invention relates to firearms training. In particular, although not exclusively, the present invention relates to firearms training using virtual environments.

### BACKGROUND ART

It is well established that regular training is essential in maintaining firearms proficiency, and many courses exist that provide both theoretical and practical training. Furthermore, even those that are highly-skilled with firearms, such as military, must train regularly to maintain their high skill levels.

Typically, such training is provided at a firearms range, as it enables live firearms training to be provided in a safe environment.

A problem, however, with such training is that it requires physical attendance at the firearms range, which in many cases may simply not be practical or possible. As an illustrative example, persons that do not live near a firearms range may not be able to practically attend such training, let alone on a regular basis.

Several attempts have been made to provide such training outside of firearms ranges, often including the use of laser-based firearm simulation equipment. In many cases, laser training devices are used that have a size and shape resembling a firearm, but emitting a laser signal when the training device is “shot”.

A problem with such laser-based simulation systems is that they generally require a large target area, such as a large screen or projector system to which a user may aim the firearm simulation equipment, and are therefore expensive and not suitable for small environments, such as the home.

A further problem with such laser-based simulation systems is that persons are training using a training device, rather than a real firearm. A real firearm may have quite a different feel to the training device, and as a result, training using a training device may not map well to experience using a real firearm.

A further problem with training on a firearms range is that the practical aspects of training primarily relate to target practice, which is very different to the speed, anxiety, and pressure of real-world situations. As a result, training in such environment may not map well to real-world experience using a firearm.

As such, there is clearly a need for improved firearms training systems and methods.

It will be clearly understood that, if a prior art publication is referred to herein, this reference does not constitute an admission that the publication forms part of the common general knowledge in the art in Australia or in any other country.

### SUMMARY OF INVENTION

The present invention is directed to firearms training systems and methods, which may at least partially overcome at least one of the abovementioned disadvantages or provide the consumer with a useful or commercial choice.

With the foregoing in view, the present invention in one form, resides broadly in a firearms training system comprising:
one or more sensors, configured to be mounted to the firearm and to track an orientation of the firearm;
a display, configured to be mounted to a firearm and to display a virtual environment in which the firearm may operate, the virtual environment updated according to an orientation of the firearm;
wherein the display is mounted to the firearm in a manner to that simulates the firearm being used in the virtual environment.

Advantageously, the firearms training system enables persons to train using a real firearm, such as their own firearm, in a safe environment (e.g. indoors) while simulating a real world environment, such as a hunting environment, a military training environment, or the like.

Preferably, the one or more sensors and the display comprise sensors and display of a portable computing device. The portable computing device may comprise a smartphone or a tablet computer.

Preferably, the one or more sensors are configured to track at least rotational movement of the firearm. Suitably, the one or more sensors may be configured to track roll, pitch and yaw of the firearm. The one or more sensors may be further configured to track translational movement of the firearm, e.g. track in six degrees of freedom.

The one or more sensors may include image sensors, wherein tracking of the firearm is performed at least in part according to tracking of images captured by the image sensors. The image sensors may comprise sensors of one or more cameras.

The one or more sensors may include an inertial measurement sensor. The one or more sensors may include a gyroscope.

Preferably, the system includes a lens, mounted in front of the display, to mimic a scope. The lens may be configured to magnify a portion of the display and/or enable the user to focus on the display when close to the display. This enables the user to hold the firearm naturally.

Preferably, the display is configured to generate a first display portion, for display through the lens, and a second display portion, for display outside of the lens. The first display portion may correspond to an enlarged portion of the virtual environment compared to the second display portion.

Preferably, the display is updated when the firearm is fired without ammunition (dry fired). The system may include a microphone, configured to sense a sound of the firearm dry-firing. Similarly, the display may be updated in the same manner when a blank is fired (i.e. blank ammunition).

The display may display a virtual target to which the firearm may aim. The display may be updated to show whether the target has been hit.

Preferably, the firearm comprises a rifle. Alternatively, the firearm may comprise a pistol.

The firearm may have a scope. The sensors and display may comprise sensors and a display of a portable computing device attached to the scope.

The display may be positioned to mimic a display of a scope of the firearm. The display may be positioned immediately in front of a scope of the firearm.

The display may be positioned behind a lens, configured to mimic a scope of the firearm.

The display may be positioned forward of a scope or sighting system of the firearm, such that the display is viewed through the scope or sighting system of the firearm.

Preferably, the one or more sensors and the display comprise sensors and a display of a portable computing device, wherein the portable computing device is mounted to the firearm by a bracket.

The bracket may extend outwardly from the firearm, and along a length of the firearm.

Preferably, the bracket is adjustable.

Preferably, the bracket includes one or more clamp members, configured to clamp at least a part of the firearm. Suitably, the clamp members are configured to clamp to a scope of the firearm.

The bracket may be configured to mount the display in front of the firearm. Such configuration is particularly relevant for pistols, which have relatively short lengths compared to rifles.

The display may be configurable to display a virtual environment of a plurality of environments.

The display may display whether a virtual target is shot or not. This display may display a score or hit rate.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a rear perspective view of a firearms training system, mounted to a rifle, according to an embodiment of the present invention.

FIG. 2 illustrates a front perspective view of the firearms training system of FIG. 1, removed from the rifle.

FIG. 3 illustrates a simplified top view of the system of FIG. 1 installed on the rifle, according to an embodiment of the present invention.

FIG. 4 illustrates a front view of a smartphone of the system of FIG. 1 including an exemplary virtual environment thereon, according to an embodiment of the present invention.

FIG. 5 illustrates a simplified top view of a system installed on the rifle, according to an alternatively embodiment of the present invention.

FIG. 6 illustrates a schematic of a system, which may be similar to the system of FIG. 1, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

Embodiments of the present invention are disclosed which provide a safe and efficient means for firearms training, which may be performed in the home. This may improve firearms skill levels, by ensuring that training is performed using a real firearm, in a safe environment.

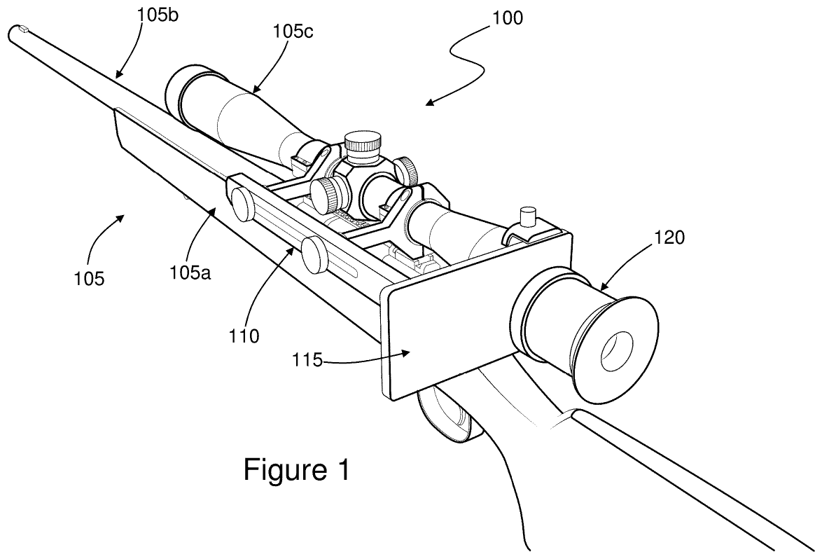

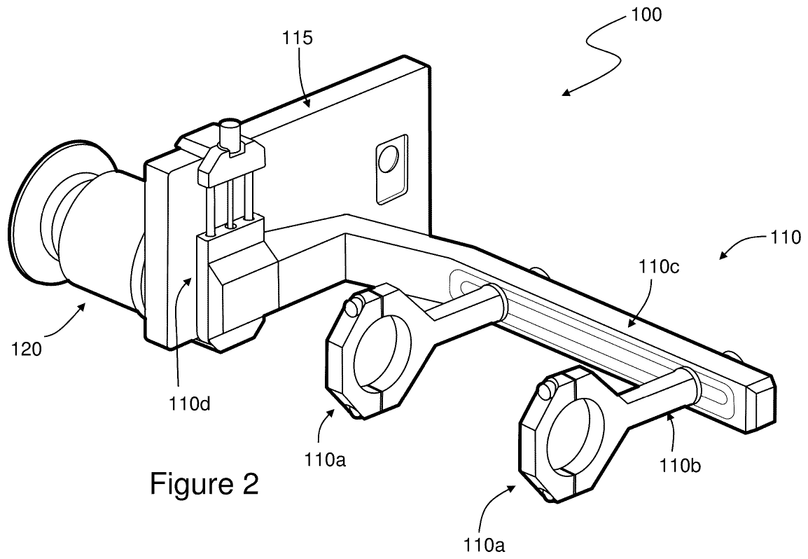

FIG. 1 illustrates a rear perspective view of a firearms training system 100, mounted to a rifle 105, according to an embodiment of the present invention. FIG. 2 illustrates a front perspective view of the firearms training system 100, removed from the rifle 105.

The rifle 105 is a conventional rifle, and includes a stock 105a, a barrel 105b and a scope 105c. While the rifle is able to fire ammunition, the firearms training system 100 enables training to be performed using the rifle 105 without ammunition, in a manner that mimics real use of the rifle 105. This in turn enables the rifle to be used in training indoors in a safe manner.

A bracket 110 is coupled to the scope 105c by clamp members 110a, such that the bracket 110 extends outwardly from the scope 105c by arms 110b, and then rearwardly, parallel to the scope, by a leg member 110c. A smartphone retaining portion 110d is then provided such that at least part of a smartphone 115 retained therein is positioned rearwardly of the scope 105c when in use.

Finally, a lens 120 is provided such that it is positioned rearwardly of the smartphone 115, and is configured to focus on a portion of a screen of the smartphone 115. The lens 120 is provided on the same axis as the scope 105c, such that a person may look through the lens 120 in a manner that mimics using the scope 105c.

The smartphone 115 includes a plurality of sensors, enabling it to track an orientation of the firearm. As the smartphone 115 is fixed to the scope 105c of the rifle 105, movement of the smartphone 115 corresponds to movement of the rifle 105. In particular, the smartphone 115 includes an inertial measurement unit/gyroscope and camera, which together track an orientation of the rifle 105, as outlined in further detail below.

The display of the smartphone 115 is configured to display a virtual environment in which the rifle 105 may operate (virtually), wherein the virtual environment updated according to an orientation of the rifle 105. In particular, when the rifle 105 is rotated (roll, yaw or pitch) in a particular direction, the display is updated such that the virtual environment is also moved in a corresponding manner. Such configuration provides a virtual reality (VR)-like experience when looking through the lens. The system 100 may also track translational movement of the rifle 105, and thereby track in six degrees of freedom.

As outlined above, the rifle 105 is used with the system 100 without ammunition. However, the rifle is used in the same manner as it would with ammunition, and thus dry fired (i.e. “fired” without ammunition). The rifle may be similarly used with blank ammunition, i.e. with ammunition that has no projectile, but provides the sound and flash of gunfire.

The smartphone 115 includes a microphone, which is configured to detect the sound of the rifle dry firing. The smartphone 115 then triggers shooting of the rifle in the virtual environment. The virtual environment includes one or more targets, and the display may show whether the target has been hit or missed.

Any suitable virtual environment may be used including a virtual hunting environment, a virtual military training environment, or the like.

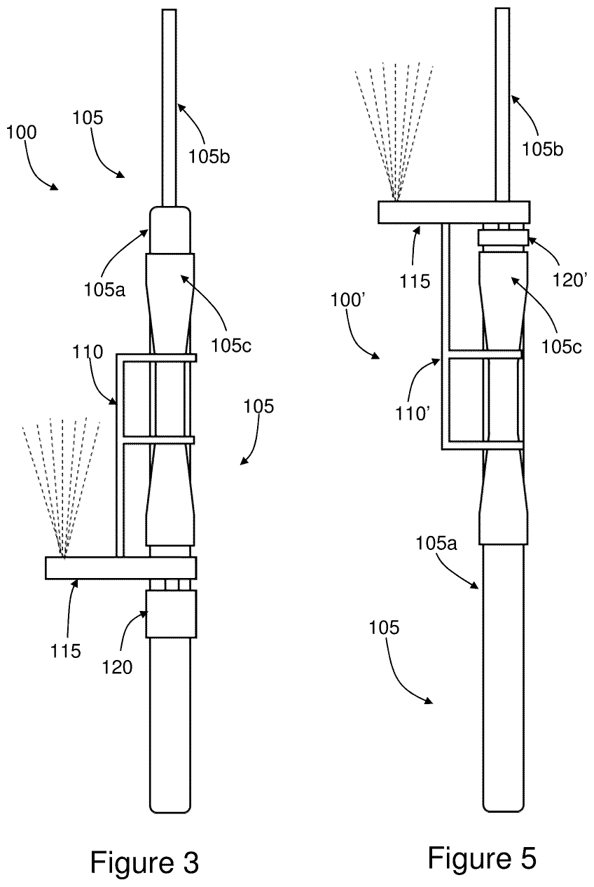

FIG. 3 illustrates a simplified top view of the system 100 installed on the rifle 105, according to an embodiment of the present invention.

The smartphone 115 is retained by the bracket 110 such that a portion of the screen is positioned directly in front of the lens 120, while extending laterally from a centre of the rifle 105 such that a camera of the smartphone 115 is able to capture images in the same general direction that the rifle is directed.

This enables tracking to be performed using the images captured by the camera, potentially together with an inertial measurement unit, gyroscope or the like. By placing the smartphone 115 in such manner, not only is a portion of the screen able to be used with the lens, but also the camera is able to be used in a relatively unshielded manner.

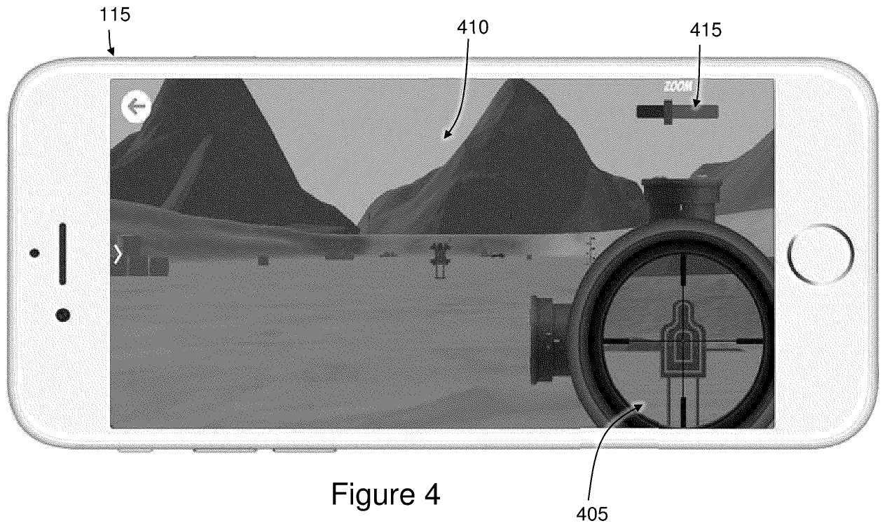

FIG. 4 illustrates a front view of the smartphone 115 including an exemplary virtual environment thereon, according to an embodiment of the present invention.

As outlined above, the system 100 includes a lens 120, mounted in front of the display (from the perspective of the user), to mimic a scope. The lens is configured to magnify a scope portion 405 of the display and enable the user to focus on the display when close to the display (e.g. about 40 mm from the user's eye). This enables the user to hold the firearm naturally, such that the lens 120 together with the scope portion 405, functions in a manner that mimics a scope in the virtual environment.

The display further includes a second display portion 410, for display outside of the lens 120. The scope display portion 405 corresponds to an enlarged portion of the virtual environment compared to the second display portion 410.

In use, a person may view the scope portion 405 through the lens 120, much like a scope would be used. The person may also look at the screen beside the lens to get a larger overview of the virtual environment.

The display is updated when the firearm is fired (without ammunition, i.e. dry fired, or fired with blank ammunition). In particular, a microphone of the smartphone 115 senses a sound of the rifle 105 dry-firing, and shoots the rifle in the virtual environment.

The display includes virtual targets to which the rifle 105 may aim. The display may be updated to show whether the target has been hit the when rifle 105 is fired.

The display includes a zoom bar 415, to change a level of zoom in the rifle 105. This may also change a rate at which the display changes depending on movement of the rifle 105. I.e. when zoomed more, movements of the rifle 105 are magnified in the virtual environment.

The skilled addressee will readily appreciate that other menus may exist, including those that enable the user to change settings of the system, change virtual environment or perform any other suitable action.

As will be readily understood by the skilled addressee, the bracket 110 may take various forms. In particular, the smartphone 115 may be retained in any suitable manner, and a universal bracket may be provided that enables multiple different types of smartphones to be used.

Similarly, the bracket 110 may attach to the rifle 105 in any suitable way, including using different fasteners. The bracket 110 may also be adjustable to suit different sized rifles and scopes.

In some embodiments, the scope 105c of the rifle 105 is used to focus on a screen of the smartphone 115, rather than having the smartphone 115 cover the scope 105c.

FIG. 5 illustrates a simplified top view of a system 100′ installed on the rifle 105, according to an alternative embodiment of the present invention. The system 100′ is similar to the system 100, but wherein the smartphone is positioned forward of the scope 105c.

In particular, the smartphone 115 is retained by the bracket 110 such that a portion of the screen is positioned directly in front of the scope 105c, while extending laterally from a centre of the rifle 105 such that a camera of the smartphone 115 is able to capture images in the same general direction that the rifle is directed.

A lens 120′ is positioned between the scope 105c and the smartphone 115 to assist the scope in focusing on the display. Alternatively, a specialised scope may be provided that is configured to focus on the display of the smartphone 115.

This enables tracking to be performed using the images capture by the camera, potentially together with an inertial measurement unit, gyroscope or the like, as outlined above.

Beneficially, the system 100′ enables the scope to be used directly. However, the remaining portion of the screen is further from the user's eyes. As such, the systems 100 and 100′ may be selected based upon user preference.

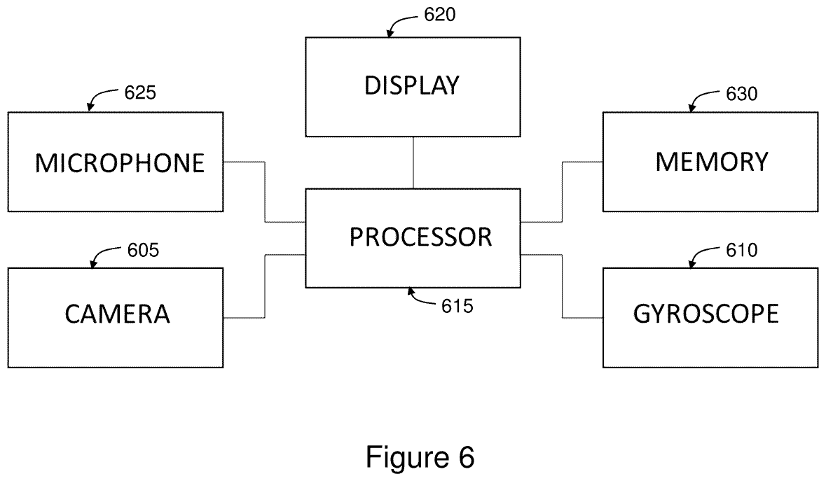

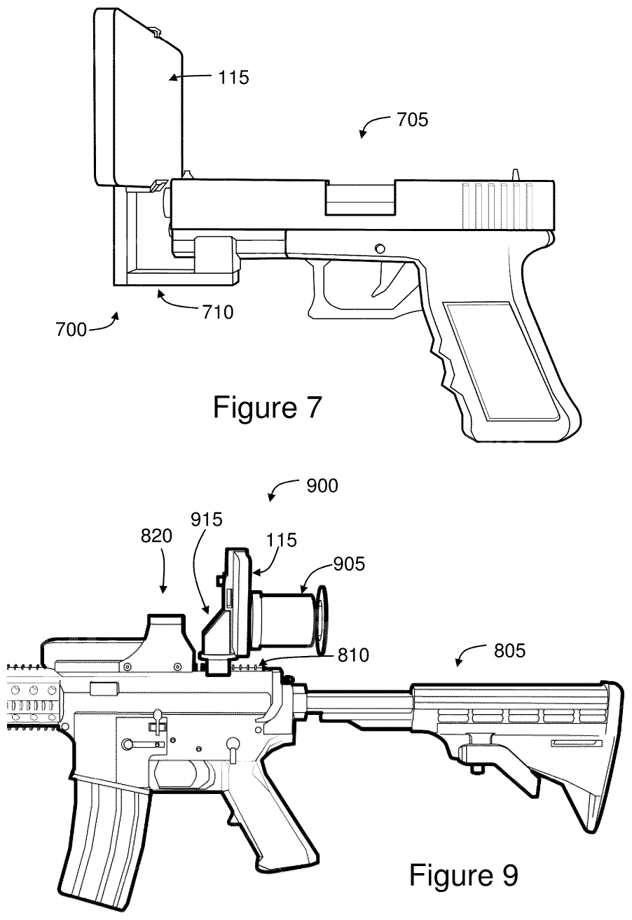

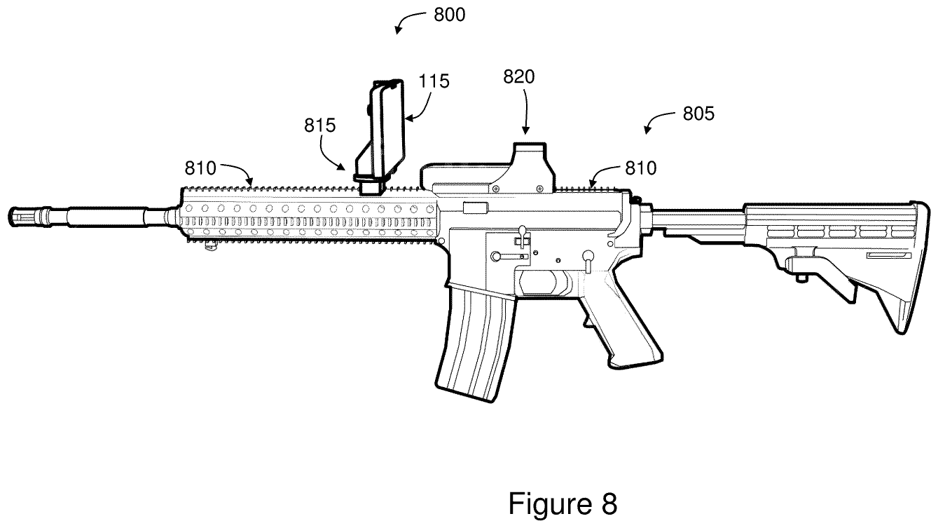

FIG. 6 illustrates a schematic of a system 600, which may be similar to the system 100, according to an embodiment of the present invention.

The system 600 includes sensors in the form of a camera 605 and a gyroscope 610, which are coupled to a processor 615 to track movement of the firearm to which the system 600 is attached. The sensors 605, 610 are configured to track at least rotational movement of the firearm, such as roll, pitch and yaw, but may also track translational movement of the firearm (e.g. tracking in six degrees of freedom).

A display 620 is also coupled to the processor, which is configured to display a virtual environment. The display may be positioned to mimic a scope of the firearm. The display may be positioned immediately in front of a scope of the firearm (from the perspective of the user), to thereby enable the firearm to be used in a similar manner to its use without the system 600.

The display may be positioned behind a lens (again from the perspective of the user), such that the lens and display mimic a scope of the firearm. Alternatively, the display may be positioned behind (forward of) a scope or sighting system of the firearm, such that the display is viewed through the scope of the firearm.

The display 620 is configured to be updated when the firearm is fired without ammunition (i.e. dry fired). In particular, a microphone 625, coupled to the processor 615, is configured to detect firing of the firearm through sound, and the processor updates the virtual environment accordingly.

Finally, the system 600 includes a memory 630, coupled to the processor. The memory includes instruction code, executable by the processor for performing the functions described herein, but also includes one or more virtual environments, which may be selected and used for training. The environments may take any suitable form, but in some embodiments include hunting environments and military training environments.

The components 605-630 may be provided in a single portable computing device, such as a smartphone or a tablet computer.

The firearm may comprise a rifle, which may have a scope, and the sensors and display may comprise sensors and a display of a portable computing device attached to the scope. The portable computing device may be mounted to the firearm by a bracket.

The firearm may comprise a pistol, and in such case, the display may be positioned in front of the pistol.

FIG. 7 illustrates a side perspective view of a firearms training system 700, mounted to a pistol 705, according to an embodiment of the present invention.

The system 700 is similar to the system 100, but configured for use with a pistol and without a scope.

The smartphone 115 is retained by a clamping member of a bracket 710 such that the screen is positioned directly in front of, and in line with, sights 705 of the pistol, such that the screen is visible directly behind the sights 705.

In particular, the bracket 710 attaches to and extends downwardly from a forward end of a barrel of the pistol 705, then outwardly (along a direction of the barrel), and upwardly such that the smartphone 115 is positioned forward of the barrel and in front of the sights 705. The camera of the smartphone 115 is thus also able to capture images in the same general direction that the pistol is directed.

Beneficially, the system 700 enables training, much like that performed above with rifles, but using pistols.

While the above systems provide examples of systems attached to rifles and pistols, the skilled addressee will readily appreciate that any suitable configuration may be used, according to the type of firearm (e.g. pistol vs. rifle), the configuration of the firearm (e.g. the sight or optics used), or due to personal preference.

As an illustrative example, AR-15 rifles include rails/receivers, which enable the attachment of a very wide range of sights and optics to be installed based upon user-preference.

FIG. 8 illustrates a side perspective view of a firearms training system 800, mounted to a rifle 805, according to an embodiment of the present invention.

The rifle 805 includes a rail receiver 810, for receiving accessories, such as sights and optics. A bracket 815 including a spring-loaded retainer engages with the rail receiver 810, extends upwardly therefrom and retains the smartphone 115. The bracket 815 and thus smartphone 115 are positioned forward of a sight 820 of the rifle 805, enabling the system 800 to be used together with the sight 820.

Such configuration enables a user of the rifle 805 to look through the sight 820, as would be done when the rifle is used normally, but looking into the phone 115 rather than the real world. As such, the user is able to hold and use the rifle 805 and use the sight 820 in a manner that is similar to use the real world, therefore providing real experience with the rifle 805, albeit in a training environment.

The same rifle 805 may be configured in a variety of ways.

FIG. 9 illustrates an enlarged side perspective view of a firearms training system 900, mounted to a rifle 805, according to an embodiment of the present invention.

The system 900 is similar to the system 800, and includes a bracket 915 that mounts to the rail receiver 810, but is mounted rearwardly of the sight 820, and includes a lens 905, which mimics function of a scope. As such, the system 900 simulates use of a scope on the rifle 805.

While the firearms illustrated above are pistols and rifles, any suitable firearm may be used, including an air or gas-powered firearm, an air rifle, an air soft gun or a gel blaster.

Advantageously, embodiments of the invention described above enable safe and efficient firearms training, which may be performed in the home. This may improve firearms skill levels, by ensuring that training is performed using a real firearm, in a safe environment.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A firearms training system comprising:
one or more sensors, configured to be mounted to the firearm and to track an orientation of the firearm;
a display, configured to be mounted to a firearm and to display a virtual environment in which the firearm may operate, the virtual environment updated according to an orientation of the firearm;
wherein the display is mounted to the firearm in a manner to that simulates the firearm being used in the virtual environment.

2. The firearms training system of claim 1, wherein the one or more sensors are configured to track at least rotational movement of the firearm.

3. The firearms training system of claim 1, wherein the one or more sensors are configured to track roll, pitch and yaw of the firearm.

4. The firearms training system of claim 3, wherein the one or more sensors are further configured to track translational movement of the firearm.

5. The firearms training system of claim 1, wherein the one or more sensors include image sensors, wherein tracking of the firearm is performed at least in part according to tracking of images captured by the image sensors.

6. The firearms training system of claim 1, wherein the one or more sensors include an inertial measurement sensor.

7. The firearms training system of claim 1, wherein the system includes a lens, mounted in front of the display, to mimic a scope of the firearm.

8. The firearms training system of claim 7, wherein the lens is configured to magnify a portion of the display and/or enable the user to focus on the display when close to the display.

9. The firearms training system of claim 7, wherein the display is configured to generate a first display portion, for display through the lens, and a second display portion, for display outside of the lens.

10. The firearms training system of claim 9, wherein the first display portion corresponds to an enlarged portion of the virtual environment compared to the second display portion.

11. The firearms training system of claim 1, wherein the display is updated when the firearm is fired without ammunition (dry fired).

12. The firearms training system of claim 11, wherein the system includes a microphone, configured to sense a sound of the firearm dry-firing.

13. The firearms training system of claim 1, wherein the display is configured to display a virtual target to which the firearm may aim, wherein the system may determine whether the virtual target has been hit at least in part according to the orientation of the firearm, and wherein the display is updated to show whether the virtual target has been hit.

14. The firearms training system of claim 1, wherein the firearm includes a scope or sighting system, wherein the display is positioned forward of a scope or sighting system of the firearm, such that the display is viewed through the scope or sighting system of the firearm.

15. The firearms training system of claim 1, wherein the one or more sensors and the display comprise sensors and a display of a portable computing device, wherein the portable computing device is mounted to the firearm by a bracket.

16. The firearms training system of claim 15, wherein the bracket extends outwardly from the firearm, and along a length of the firearm.

17. The firearms training system of claim 15, wherein the bracket is adjustable.

18. The firearms training system of claim 15, wherein the bracket includes one or more clamp members, configured to clamp at least a part of the firearm.

19. The firearms training system of claim 1, wherein the bracket is configured to mount the display in front of the firearm.

20. The firearms training system of claim 1, wherein the display is configurable to display a virtual environment of a plurality of environments.

21. (canceled)
